(19) United States
(12) Patent Application Publication
(10) Pub. No.: US 2006/0049387 A1
(43) Pub. Date: Mar. 9, 2006

(54) Crosslinkable side-chain polyimides for NLO applications

(76) Inventor: Diyun Huang, Bothell, WA (US)

Correspondence Address: FISH & RICHARDSON P.C., PO BOX 1022, MINNEAPOLIS, MN, 55440-1022, US

(21) Appl. No.: 11/207,303

(22) Filed: Aug. 19, 2005

Related U.S. Application Data
(60) Provisional application No. 60/603,801, filed on Aug. 23, 2004.

(51) Int. Cl. G02B 5/23; B32B 27/00

(52) U.S. Cl. 252/586; 428/473.5

(57) ABSTRACT

Aromatic polyimide polymers and copolymers are described that have pendant side-chain crosslinkable groups. The polymers and copolymers may further include pendant side-chain NLO chromophores. The polymers and copolymers are useful in a variety of NLO applications.

### RELATED APPLICATIONS

This application claims priority under 35 USC §119(e)(1) to U.S. Provisional Application Ser. No. 60/603,801, filed on Aug. 23, 2004, the entire contents of which are hereby incorporated by reference.

All patents, patent applications, and publications cited within this application are incorporated herein by reference to the same extent as if each individual patent, patent application, or publication were specifically and individually incorporated by reference.

### STATEMENT REGARDING FEDERALLY SPONSORED RESEARCH OR DEVELOPMENT

This invention was made with U.S. Government support pursuant to Contract No. NRO000-01-C-0315. Accordingly, the Government has certain rights in the invention.

### BACKGROUND

The invention relates generally to crosslinkable polymers for second order nonlinear optical (NLO) applications.

It is desirable for high μβ chromophore-containing, NLO polymer materials to combine a high r33 value with good temporal thermal stability following poling; the latter ensures that the aligned dipoles created as a result of poling are retained, rather than being allowed to relax and thus dissipate over time. In general, crosslinked polymers exhibit good thermal stability. It would be useful to be able to crosslink the polymers at the same temperatures selected for optimum poling results. Such temperatures, however, are typically on the order of 150° C. or higher. Many conventional cross-linkable polymers lack sufficiently high Tg values to withstand these temperatures.

### SUMMARY

In general, aromatic polyimide polymers and copolymers are described that have pendant side-chain crosslinkable groups. The polymers and copolymers may further include pendant side-chain NLO chromophores. The chromophores, in turn, may also be provided with crosslinkable groups. Alternatively, the polymers and copolymers may be blended with the chromophores to form guest/host compositions.

The polyimide polymers and copolymers may be prepared by reacting an aromatic dianhydride with an aromatic diamine. The dianhydride, diamine, or both also include a functional group that acts as a site for covalently bonding the pendant crosslinking molecules, chromophores, or both in subsequent reactions. Examples of suitable functional groups include oxygen, nitrogen, or sulfur-containing groups such as hydroxyl, amino, amido, thio, mercapto, carboxy, and carboxyl groups, and the like. Preferably, the dianhydride, the diamine, or both, also contain one or more fluorine atoms.

Examples of useful crosslinkable groups include fluorinated molecules such as fluorinated vinyl ethers (e.g., phenyl trifluorovinyl ether) and pentafluorobenzene. Such groups are thermally activated at roughly the same temperatures required for optimum poling. In some embodiments, the crosslinkable groups are covalently bonded to the polyimide polymer or copolymer main chain via an ester linkage.

Useful NLO chromophores have the general structure D-π-A, where D is a donor, π is a π-bridge, and A is an acceptor. In the art, a “π-bridge” is sometimes referred to as a “π-conjugated bridge,” “π-electron bridge,” “conjugated π-electron bridge,” and the like. Examples of donors (D) that may be used include structures chosen from the group consisting of

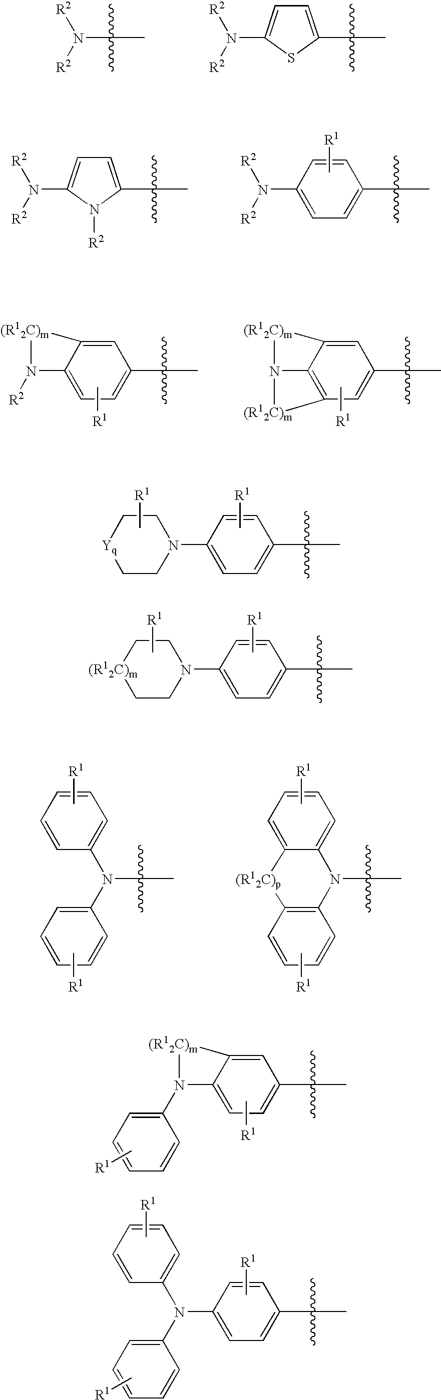

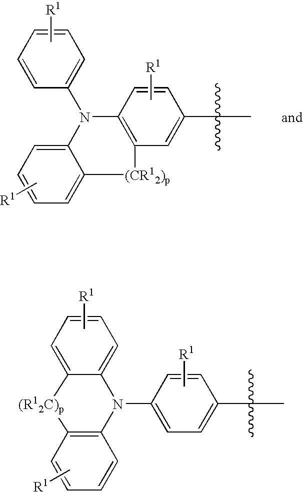

Examples of acceptors (A) that may be used include structures selected from the group consisting of 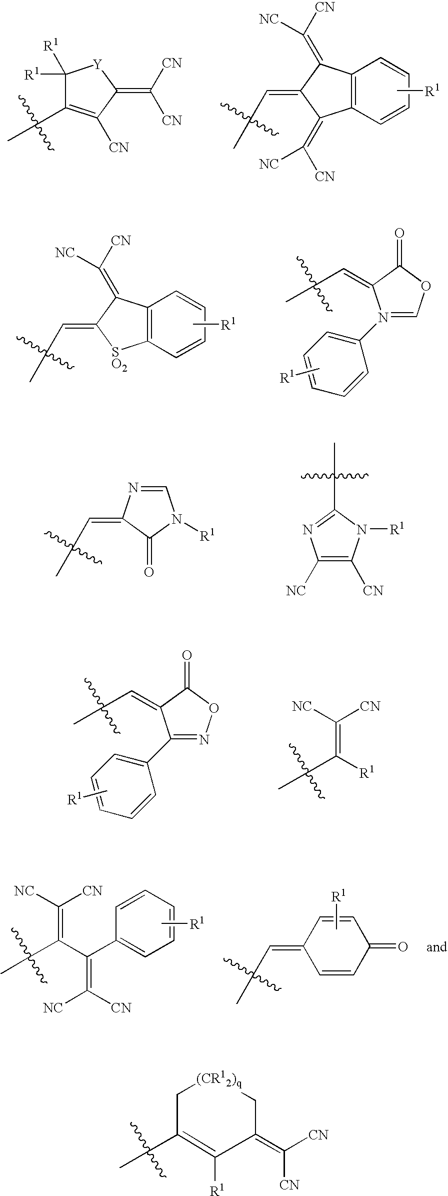
wherein independently at each occurrence: R¹ is hydrogen, a halogen except when bonded to a carbon alpha to or directly to a nitrogen, oxygen, or sulfur atom, or an alkyl, aryl, heteroalkyl, or heteroaryl group; R² is hydrogen or an alkyl, aryl, heteroalkyl, or heteroaryl group; Y is O, S or Se; m is 2, 3 or 4; p is 0, 1 or 2; and q is 0 or 1. These groups may be substituted (e.g., with halogen atoms) or unsubstituted. Preferably, the acceptor comprises the structure 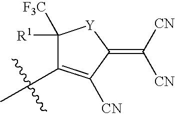
   wherein R¹ comprises an alkyl, aryl, heteroalkyl, or heteroaryl group.

In some embodiments, π is a π bridge that includes a thiophene ring having oxygen atoms bonded directly to the 3 and 4 positions of the thiophene ring, D is a donor, and A is an acceptor. The oxygens bonded directly to the 3 and 4 ring positions of the of the thiophene ring may be further independently substituted with an alkyl group comprising 1 to about 20 carbons, a heteroalkyl group comprising 1 to about 20 carbons, an aryl group comprising 1 to about 20 carbons, or a heteroaryl group comprising 1 to about 20 carbons.

In some embodiments, the chromophore has the formula: 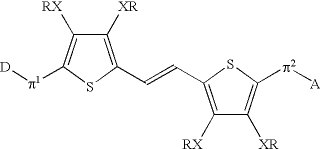
wherein, independently at each occurrence: π¹ is absent or a π-bridge; π² is absent or a π-bridge; D is a donor; A is an acceptor; X is O or S; and R is an alkyl group comprising 1 to about 20 carbons, a heteroalkyl group comprising 1 to about 20 carbons, an aryl group comprising 1 to about 20 carbons, or a heteroaryl group comprising 1 to about 20 carbons.

The polyimide polymers and copolymers offer several advantages. Because the polymers and copolymers have relatively high Tg's, they can be crosslinked and poled at temperatures designed for optimum poling. The resulting NLO materials combine high r33 values with good temporal thermal stability. In addition, covalently bonding the NLO chromophores to the polyimide backbone creates a one component system that eliminates compatibility problems that sometimes exist when polymers are physically blended with the chromophores. Eliminating the compatibility issue, in turn, reduces overall optical loss.

The details of one or more embodiments of the invention are set forth in the accompanying drawings and the description below. Other features, objects, and advantages of the invention will be apparent from the description and drawings, and from the claims.

### DETAILED DESCRIPTION

The polyimide NLO polymers and copolymers are described in the Summary of the Invention, above. One example of a synthesis used to prepare a useful polymer is shown below:

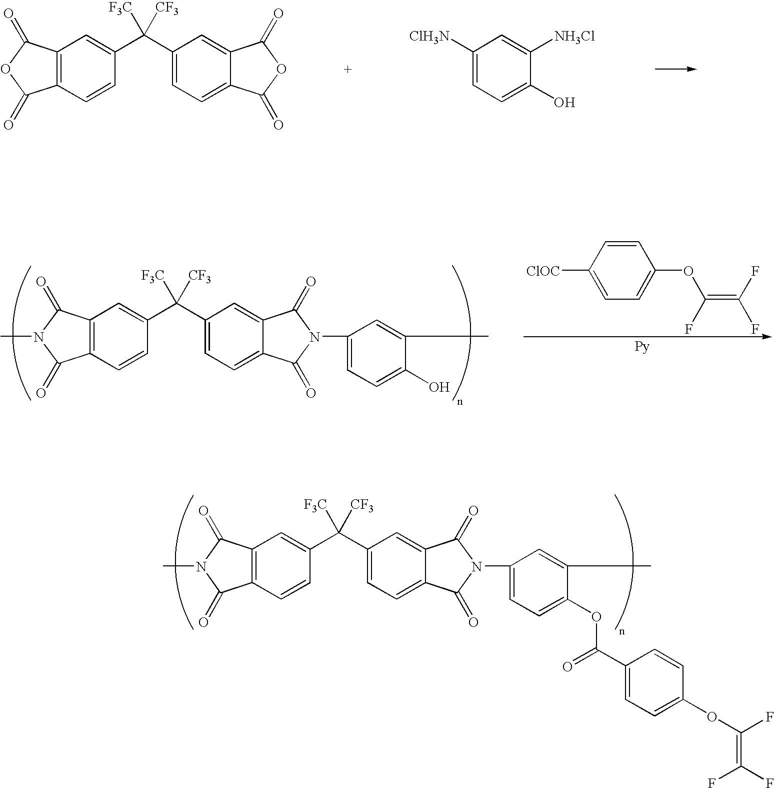

Other useful polyimides, prepared from different monomers, include the following:

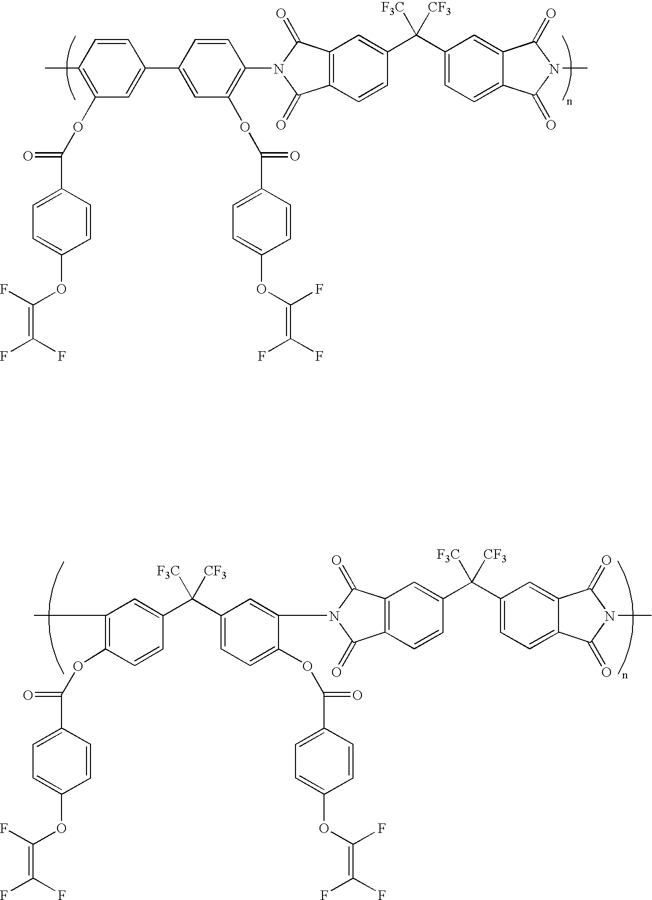

The concentration of crosslinking groups is determined by the stoichiometry of the reactants.

The NLO chromophore may be blended with the polymer to create an electro-optic composition. Preferably, however, the chromophore is covalently incorporated into the polymer as a side chain. The chromophore may also include a crosslinking group. The relative concentration of side chain chromophores and crosslinking groups is determined by the stoichiometry of the reactants.

Specific examples of useful NLO polymers, and their syntheses, are described in the Examples section, below.

The nonlinear optical compositions may be used to fabricate optical devices, optical switches, modulators, waveguides, or other electro-optical devices that can be used in communication systems using methods known in the art. For example, in optical communication systems, devices fabricated including compositions described above may be incorporated into routers for optical communication systems, waveguides for optical communication systems, or for optical switching or computing applications. Because polymers are generally less demanding than currently used materials, devices including compositions described above may be more highly integrated.

Specific examples of components of optical communication systems that may be fabricated in whole or in part from the nonlinear optical compositions described above include, without limitation, straight waveguides, bends, single-mode splitters, couplers (including directional couplers, MMI couplers, star couplers), routers, filters (including wavelength filters), switches, modulators (optical and electro-optical, e.g., birefringent modulator, the Mach-Zehnder interferometer, and directional and evanescent coupler), arrays (including long, high-density waveguide arrays), optical interconnects, optochips, single-mode DWDM components, and gratings.

Waveguides made with nonlinear optical compositions described above may be used in telecommunication, data communication, signal processing, information processing, and radar system devices and thus may be used in communication methods relying, at least in part, on the optical transmission of information. Specific applications in which the above-described nonlinear optical compositions can be incorporated include:

(1) an electro-optic device that is an interferometric optical modulator or switch, comprising: 1) an input waveguide; 2) an output waveguide; 3) a first leg having a first end and a second end, the first leg being coupled to the input waveguide at the first end and to the output waveguide at the second end; and 4) and a second leg having a first end and a second end, the second leg being coupled to the input waveguide at the first end and to the output waveguide at the second end, wherein at least one waveguide includes a nonlinear optical composition described above.

(2) an optical modulator or switch, comprising: 1) an input; 2) an output; 3) a first waveguide extending between the input and output; and 4) a second waveguide aligned to the first waveguide and positioned for evanescent coupling to the first waveguide; wherein at least one waveguide includes a nonlinear optical composition described above.

(3) an optical router that includes at least one optical modulator, optical switch, or optical directional coupler comprising a nonlinear optical composition described above.

Additional applications include a communications system including at least one electro-optic device comprising a nonlinear optical composition described above, a method of data transmission including transmitting light through a nonlinear optical composition described above, a method of telecommunication including transmitting light through a nonlinear optical composition described above, a method of transmitting light including directing light through or via a nonlinear optical composition described above, and a method of routing light through an optical system comprising transmitting light through or via a nonlinear optical composition described above.

Additionally, the nonlinear optical compositions described herein may be applied to devices or methods that control the phase of light waves passing through the material. In some applications, electrical fields are applied across a set of waveguides through which the light waves travel. Controlling the electrical fields allows the relative phases of the light waves to be controlled. Such approaches are particularly useful in applications known in the art such as phased-array radar or phase matching of light waves passing through alternative waveguides, for example see, U.S. Pat. Nos. 5,353,033; 5,051,754; 4,258,386; and 4,028,702. Thus, another embodiment is a phased-array radar comprising a nonlinear optical composition embodiment described above.

The following examples are illustrative and are not intended as a limitation thereof.

### EXAMPLES

A. Synthesis of NLO Chromophores

### Example A1—Synthesis of Chromophore DH-21

The first reaction sequence in the synthesis of Chromophore DH-21 is shown schematically below:

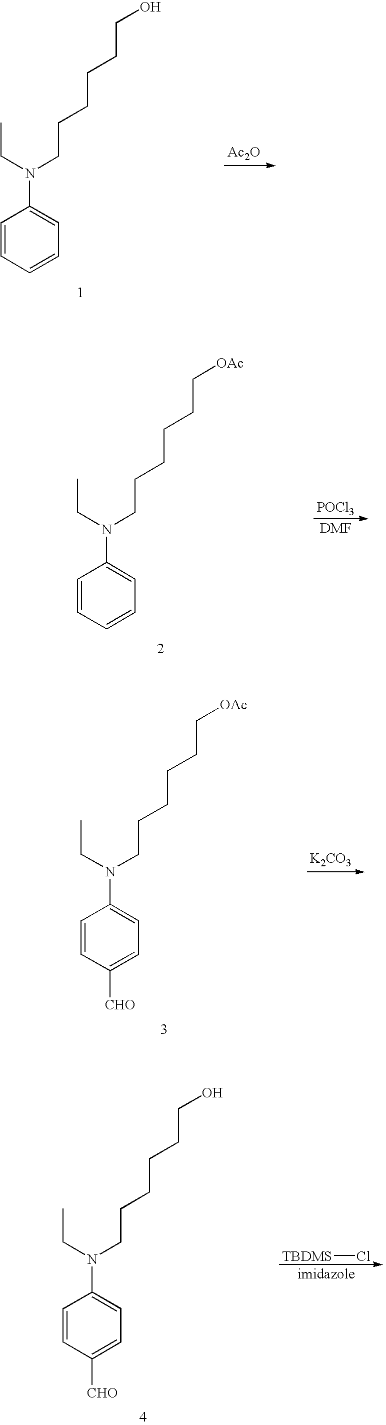

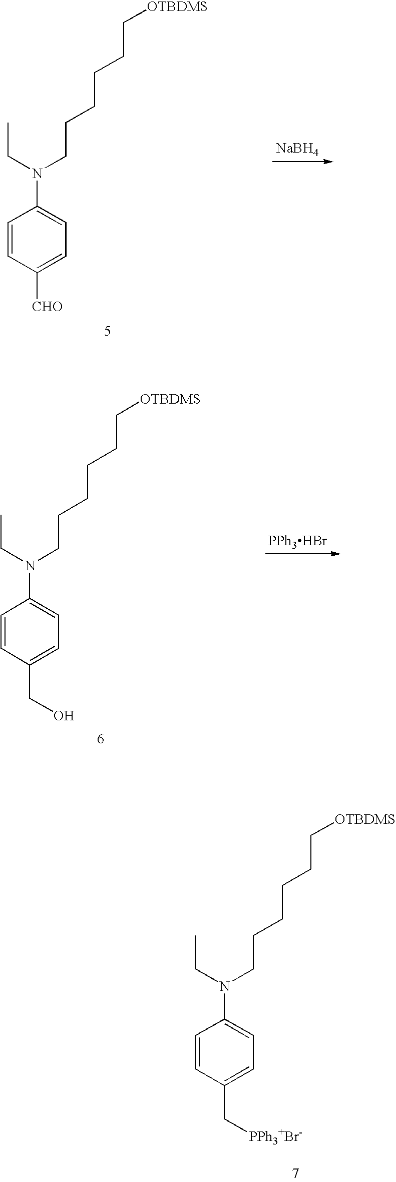

The individual compounds in the reaction sequence were synthesized as follows:

Compound 2: Compound 1 (111 g, 0.5 mol) and acetic anhydride (76.5 g, 0.75 mol) were mixed and heated to 65° C. for 20 h. The reaction mixture was poured into water and extracted with CH₂Cl₂. The crude oil was purified by flash column chromatography with hexane/ethyl acetate (3:1). Compound 2, 110 g, was obtained with 84% yield.

Compound 3: DMF (45.5 g, 0.624 mol) was placed in a three neck flask. At 0° C., POCl₃ (76.3 g, 0.499 mol) was added dropwise. Compound 2 (109.5 g, 0.416 mol) was then added. The reaction mixture was stirred at rt for 30 min and then heated at 100° C. for 3 h. The reaction mixture was then poured into water and neutralized with NaHCO₃. After extraction with CH₂Cl₂, the mixture was purified by flash column chromatography with hexane/ethyl acetate (5:2). Compound 3, 96.2 g, was obtained with 80% yield.

Compound 4: Compound 3 (96 g, 0.33 mol) and 600 mL ethanol were mixed. K₂CO₃ (50 g, 0.36 mol) was added while stirring. The mixture was stirred at rt for 4 h. CH₂Cl₂ was added and then the reaction mixture was dried over MgSO₄. After filtration and removing the solvent, it was purified by flash column chromatography with ethyl acetate/CH₂Cl₂ (3:2). Compound 4, 54.3 g, was obtained with 66% yield.

Compound 5: Compound 4 (54 g, 0.217 mol), TBDMS-Cl (42.4 g, 0.282 mol), imidazole (38.3 g, 0.563 mol), and 140 mL DMF were mixed and heated at 50° C. for 10 h. The mixture was poured into water and extracted with CH₂Cl₂. Next, it was purified with hexane/ethyl acetate (3:1). Compound 5, 68.2 g, was obtained with 87% yield.

Compound 6: Compound 5 (68 g, 0.187 mol) was dissolved in 200 mL methanol. NaBH₄ was mixed with 7% NaOH solution (4 mL), diluted with 30 mL water, and then added dropwise into the above solution at 0° C. After stirring at rt for 3 h, the mixture was poured into water and extracted with CH₂Cl₂. It was then purified by flash column chromatography with hexane/ethyl acetate (2:1). Compound 6, 58 g, was obtained with 84% yield.

Compound 7: Compound 6 (57.5 g, 0.157 mol), PPh₃.HBr (48.6 g, 0.142 mol), and 400 mL CHCl₃ were mixed and heated to reflux for 3 h with a Dean-Stark set-up. The mixture was then condensed by removing most of the solvent and precipitated with diethyl ether. Compound 7, 82 g, was obtained with 84% yield.

The second reaction sequence in the synthesis of Chromophore DH-21 begins with Compound 7, and is shown schematically below:

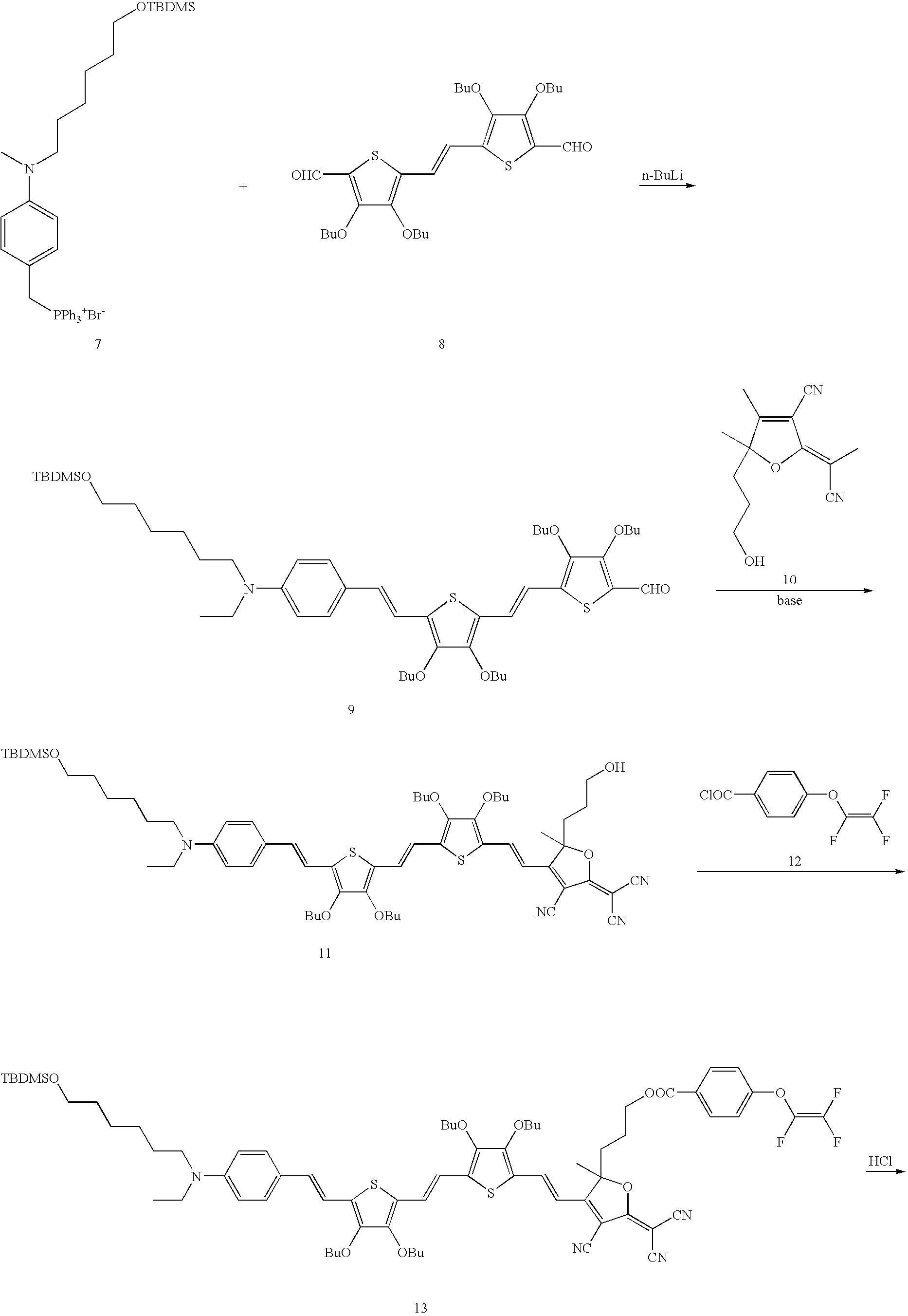

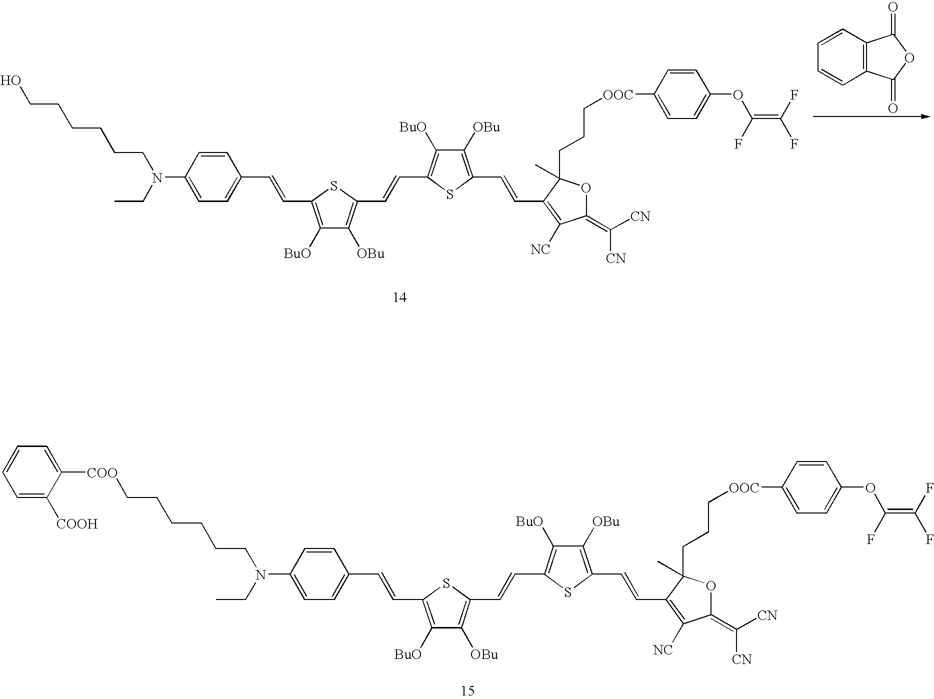

The individual compounds in the reaction sequence were synthesized as follows:

Compound 9: Compound 7 (71 g, 0.103 mol) was dissolved in 2000 mL THF. At −40° C., BuLi (45 mL, 0.113 mol) was added dropwise. The resulting reaction mixture was stirred at rt for 30 min. The solution was then added dropwise into a solution of Compound 8 (48 g, 0.09 mol) in 1400 mL THF. Next, the reaction mixture was stirred for 10 h. After removing the solvent, it was purified by flash column chromatography with CH₂Cl₂/hexane/ethyl acetate (4:4:0.2). Compound 9, 58.1 g, was obtained in 75% yield.

Compound 11: Compound 9 (30 g, 34.5 mmol), Compound 10 (10 g, 41.5 mmol), piperidene (catalytic amount), and 15 mL CHCl₃ were mixed and heated to reflux for 5 h. The reaction mixture was purified by flash column chromatography with hexane/ethyl acetate/CH₂Cl₂ (4:1.2:4). Compound 11, 15.6 g, was obtained with 45% yield.

Compound 13: Compound 11 (7.13 g, 6.52 mmol) and pyridine (1.32 mL, 16.3 mmol) were dissolved in 80 mL CH₂Cl₂. Compound 12 (3.1 g, 13.04 mmol) in 10 mL CH₂Cl₂ was added dropwise at 0° C. The mixture was stirred at rt for 12 h and then poured into water. It was extracted with CH₂Cl₂ and purified by flash column chromatography with hexane/CH₂Cl₂/ethyl acetate (4:4:0.4). Compound 13, 7.7 g, was obtained with 91% yield.

Compound 14: Compound 13 (7.6 g, 5.875 mmol) was dissolved in 150 mL THF. HCl solution (1N, 50 mL) was then added. The resulting reaction mixture was stirred at rt for 12 h and then neutralized with NaHCO₃ solution. After extraction with CH₂Cl₂, it was purified by flash column chromatography with hexane/CH₂CL₂/ethyl acetate (1:2:1). Compound 14, 5.7 g, was obtained in 82% yield.

Compound 15: Compound 14 (1 g, 0.848 mmol), DMAP (0.021 g, 0.017 mmol), and triethyl amine (0.24 mL, 1.7 mmol) were dissolved in 30 mL CH₂Cl₂. Phthalic anhydride (0.157 g, 1.06 mmol) was added and the resulting reaction mixture was stirred at rt for 12 h. It was then washed with 1N HCl solution, extracted with CH₂Cl₂, and washed with NaHCO₃ solution and water. The mixture was purified by flash column chromatography with CH₂Cl₂/acetone (2.5:1). Compound 15, which corresponds to Chromophore DH-21, 0.82 g, was obtained with 73% yield.

### Example A2—Synthesis of Chromophore DH-26

The reaction sequence used to prepare Chromophore DH-26 is shown schematically below:

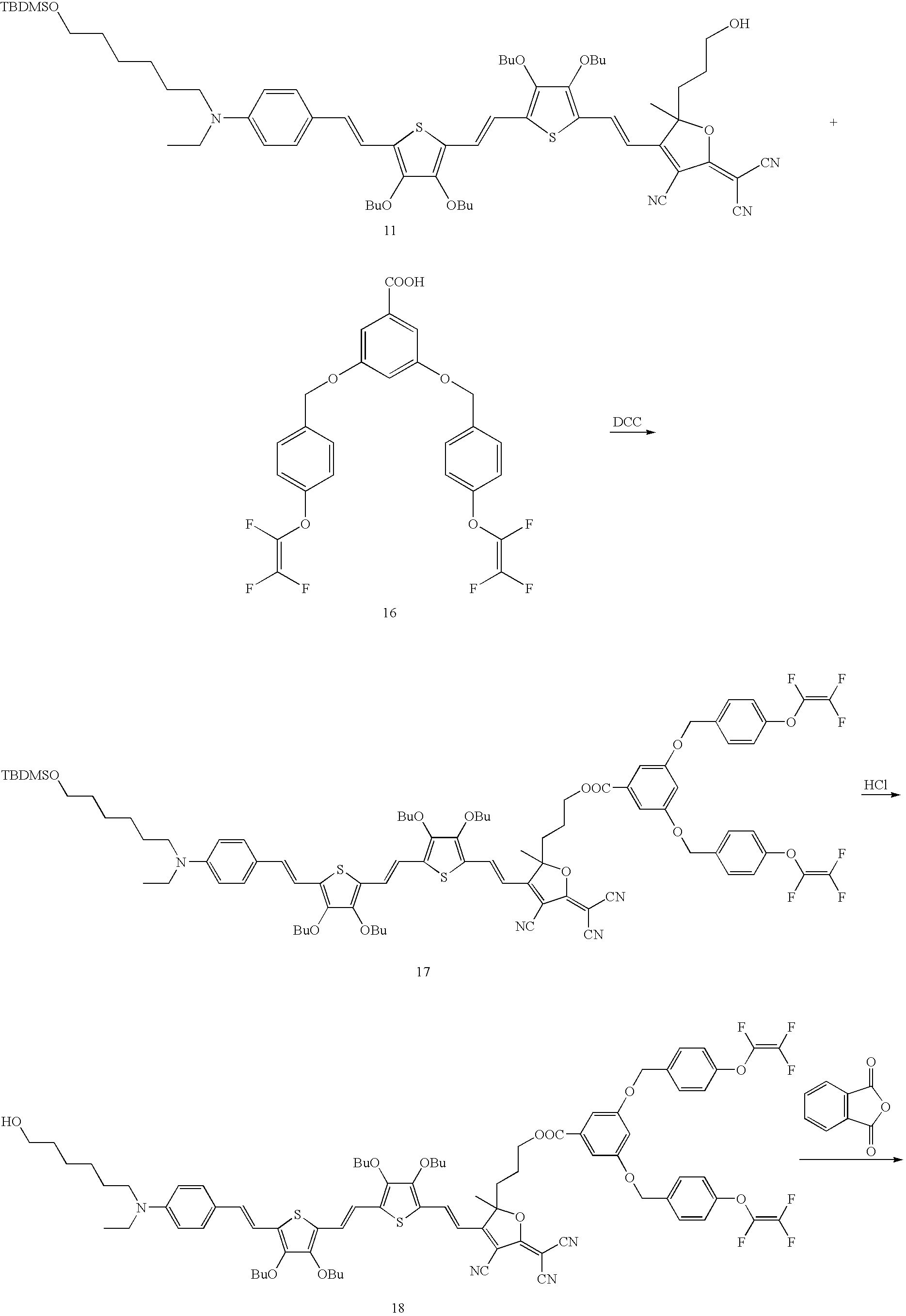

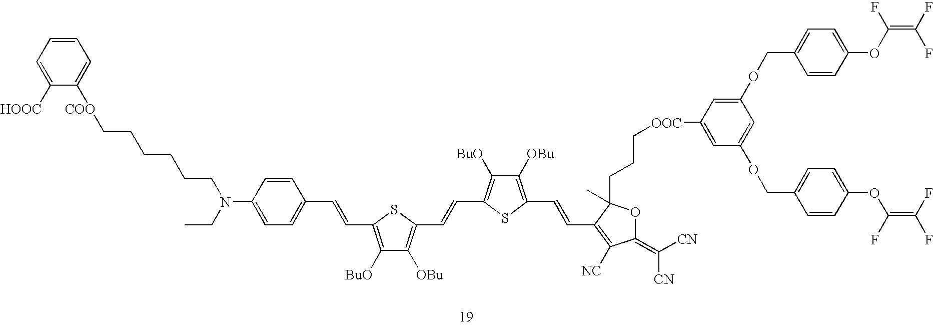

The individual compounds were synthesized as follows:

Compound 17: Compound 11 (4.2 g, 3.84 mmol), synthesized as described above in Example A1, Compound 16 (2.63 g, 4.99 mmol), and DPTS (0.3 g, 1.01 mmol) were dissolved in 30 mL CH₂Cl₂. DCC (1.23 g, 5.95 mmol) was added and the resulting reaction mixture was stirred at rt for 12 h. After filtering and removing the solvent, the mixture was purified using flash column chromatography with hexane/CH₂Cl₂/ethyl acetate (4:4:0.4). Compound 17, 5.88 g, was obtained with 95.6% yield.

Compound 18: Compound 17 (5.85 g, 3.65 mmol) was dissolved in 100 mL THF. HCl solution (1N, 30 mL) was added and the resulting reaction mixture was stirred at rt for 12 h. The mixture was then extracted with CH₂Cl₂ and washed with NaHCO₃ solution. It was purified by flash column chromatography with CH₂Cl₂/ethyl acetate (12:1). Compound 18, 4.77 g, was obtained with 88% yield.

Compound 19: Compound 18 (3.5 g, 2.35 mmol), DMAP (0.057 g, 0.47 mmol), and triethyl amine (0.66 mL, 4.71 mmol) were dissolved in 70 mL CH₂Cl₂. Phthalic anhydride (0.44 g, 2.94 mmol) was added and the resulting reaction mixture was stirred at rt for 12 h. It was then washed with 1N HCl solution, extracted with CH₂Cl₂, and washed with NaHCO₃ solution and water. The mixture was purified by flash column chromatography with CH₂Cl₂/acetone (2.5:1). Compound 19, which corresponds to Chromophore DH-26, 2.3 g, was obtained with 60% yield.

### Example A3—Synthesis of Chromophore DH-33

The reaction sequence used to prepare Chromophore DH-33 is shown schematically below:

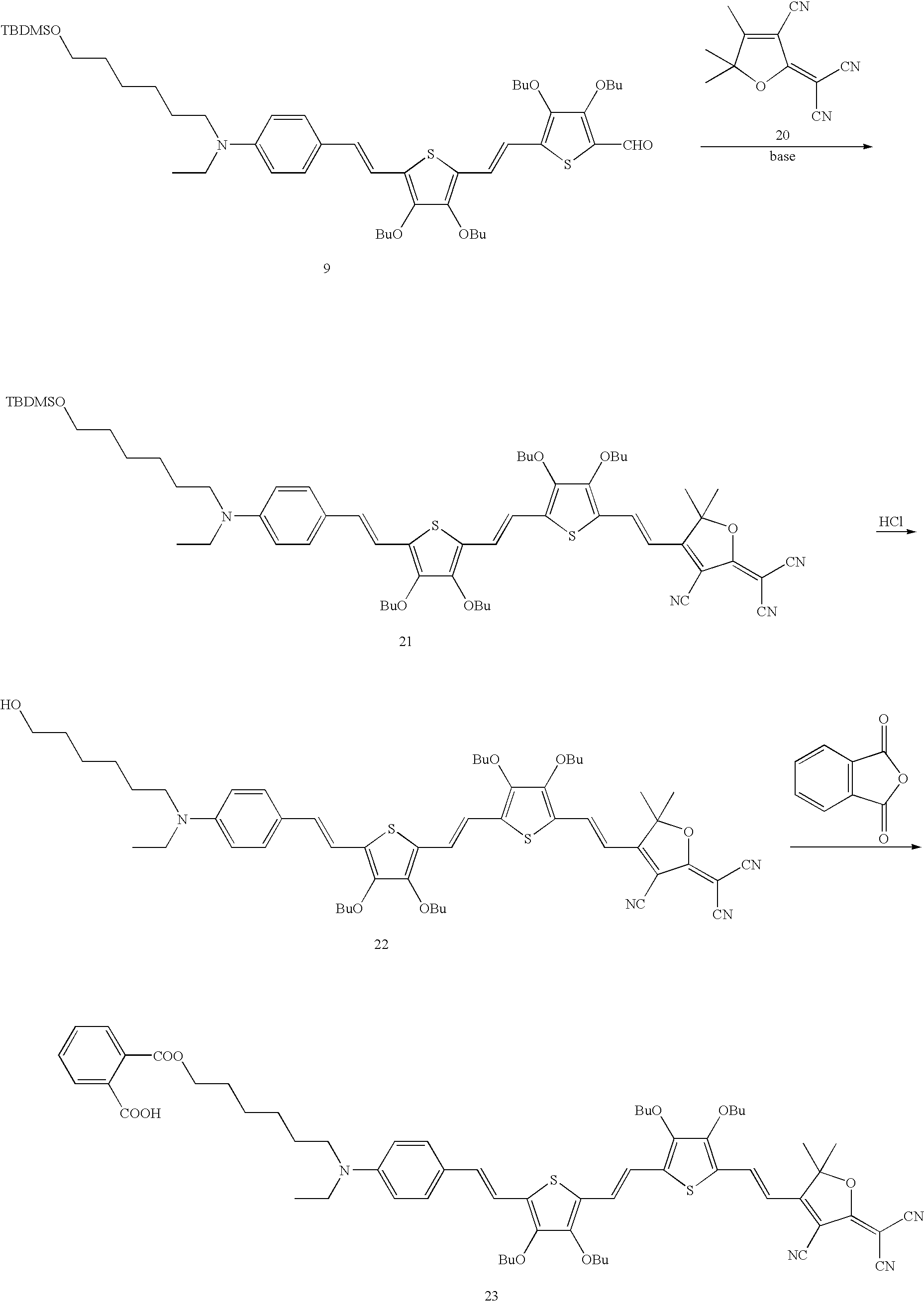

The individual compounds were synthesized as follows:

Compound 21: Compound 9 (10 g, 11.5 mmol), prepared as described in Example A1, Compound 20 (4.6 g, 23 mmol), piperidene (catalytic amount), and 5 mL CHCl₃ were mixed and heated to reflux for 5 h. The reaction mixture was purified by flash column chromatography with hexane/ethyl acetate/CH₂Cl₂ (4:0.15:4). Compound 21, 5.35 g, was obtained with 44% yield.

Compound 22: Compound 21 (11.1 g, 10.6 mmol) was dissolved in 350 mL THF.

HCl solution (1N, 100 mL) was added. The resulting reaction mixture was stirred at rt for 12 h and then neutralized with NaHCO₃ solution. After extraction with CH₂Cl₂, it was purified by flash column chromatography with CH₂Cl₂/ethyl acetate (6:1). Compound 22, 9 g, was obtained in 90% yield.

Compound 23: Compound 22 (10 g, 10.7 mmol), DMAP (0.26 g, 2.1 mmol), and triethyl amine (3 mL, 21.4 mmol) were dissolved in 300 mL CH₂Cl₂. Phthalic anhydride (2 g, 13.4 mmol) was added and the resulting reaction mixture was stirred at rt for 12 h. It was then washed with 1N HCl solution, extracted with CH₂Cl₂, and washed with NaHCO₃ solution and water. The mixture was purified by flash column chromatography with CH₂Cl₂/acetone (2.5:1). Compound 23, which corresponds to Chromophore DH-33, 10.4 g, was obtained with 90% yield.

### Example A4—Synthesis of Chromophore DH-36

The reaction sequence used to synthesize Chromophore DH-36 is shown schematically below:

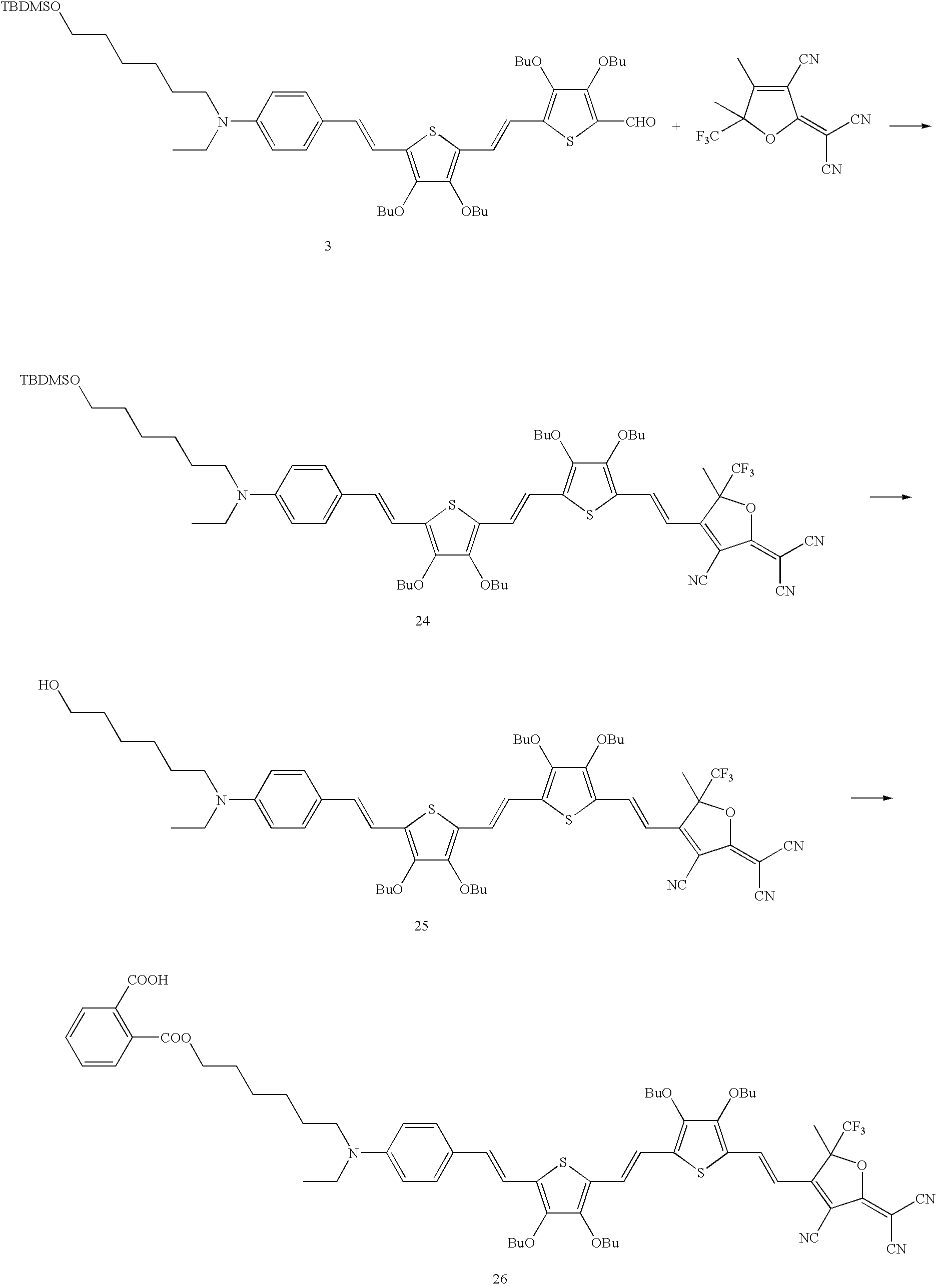

The individual compounds were synthesized as follows:

Compound 24: Compound 3, prepared as described in Example A1, (9.9 g, 11.5 mmol) and CF₃-TCF (2.9 g, 11.5 mmol) were mixed with 60 mL ethanol and heated to reflux for 2 h. The CF3-TCF acceptor can be prepared as in Liu, S et al., Adv. Mater. 2003, 15, 603-607. After removing the solvent, the reaction mixture was purified by flash column with hexane/ethyl acetate/CH₂Cl₂ (4:0.1:4). Compound 24, 5.1 g, was obtained with 40% yield.

Compound 25: Compound 24 (4.1 g, 3.72 mmol) was dissolved in 120 mL THF. HCl solution (1N, 38 mL) was added. The resulting reaction mixture was stirred at rt for 12 h and then neutralized with NaHCO₃ solution. After extraction with CH₂Cl₂, it was purified by flash column chromatography with hexane/CH₂CL₂/ethyl acetate (4:4:0.3). Compound 25, 3.4 g, was obtained in 93% yield.

Compound 26: Compound 25 (3.2 g, 3.23 mmol), DMAP (0.08 g, 0.65 mmol), and triethyl amine (0.9 mL, 6.47 mmol) were dissolved in 95 mL CH₂Cl₂. Phthalic anhydride (0.6 g, 4.04 mmol) was added and the resulting reaction mixture was stirred at rt for 12 h. It was then washed with 1N HCl solution, extracted with CH₂Cl₂, and washed with NaHCO₃ solution and water. The mixture was purified by flash column chromatography with CH₂Cl₂/acetone (3:1). Compound 26, which corresponds to Chromophore DH-36, was obtained with 87% yield.

### Example A5—Synthesis of Chromophore DH-38

Chromophore DH-38 was synthesized according to the following reaction scheme:

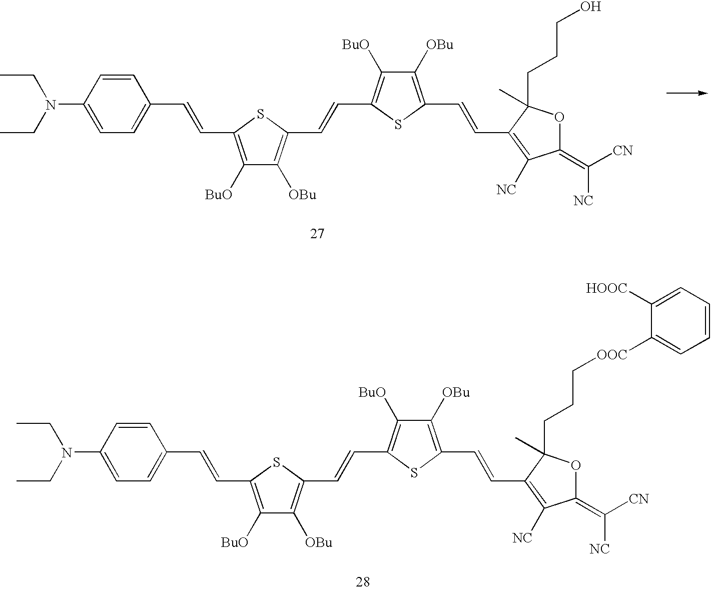

The individual compounds were synthesized as follows:

Compound 27: Compound 27 was prepared according to the procedure used to prepared Compound 11, with the exception that a different triphenyl phosphonium bromide reactant was substituted for Compound 7.

Compound 28: Compound 27 (3.5 g, 3.86 mmol), DMAP (0.094 g, 0.77 mmol), and triethyl amine (1.1 mL, 7.7 mmol) were dissolved in 100 mL CH₂Cl₂. Phthalic anhydride (0.71 g, 4.82 mmol) was added and the resulting reaction mixture was stirred at rt for 12 h. It was then washed with 1N HCl solution, extracted with CH₂Cl₂, and washed with NaHCO₃ solution and water. The mixture was purified by flash column chromatography with CH₂Cl₂/acetone (3:1). Compound 28, which corresponds to Chromophore DH-38, 3.7 g, was obtained with 91% yield.

B. Synthesis of Crosslinkable Side-Chain Polyimides

### Example B1

A crosslinkable side-chain polyimide was prepared according to the following reaction scheme:

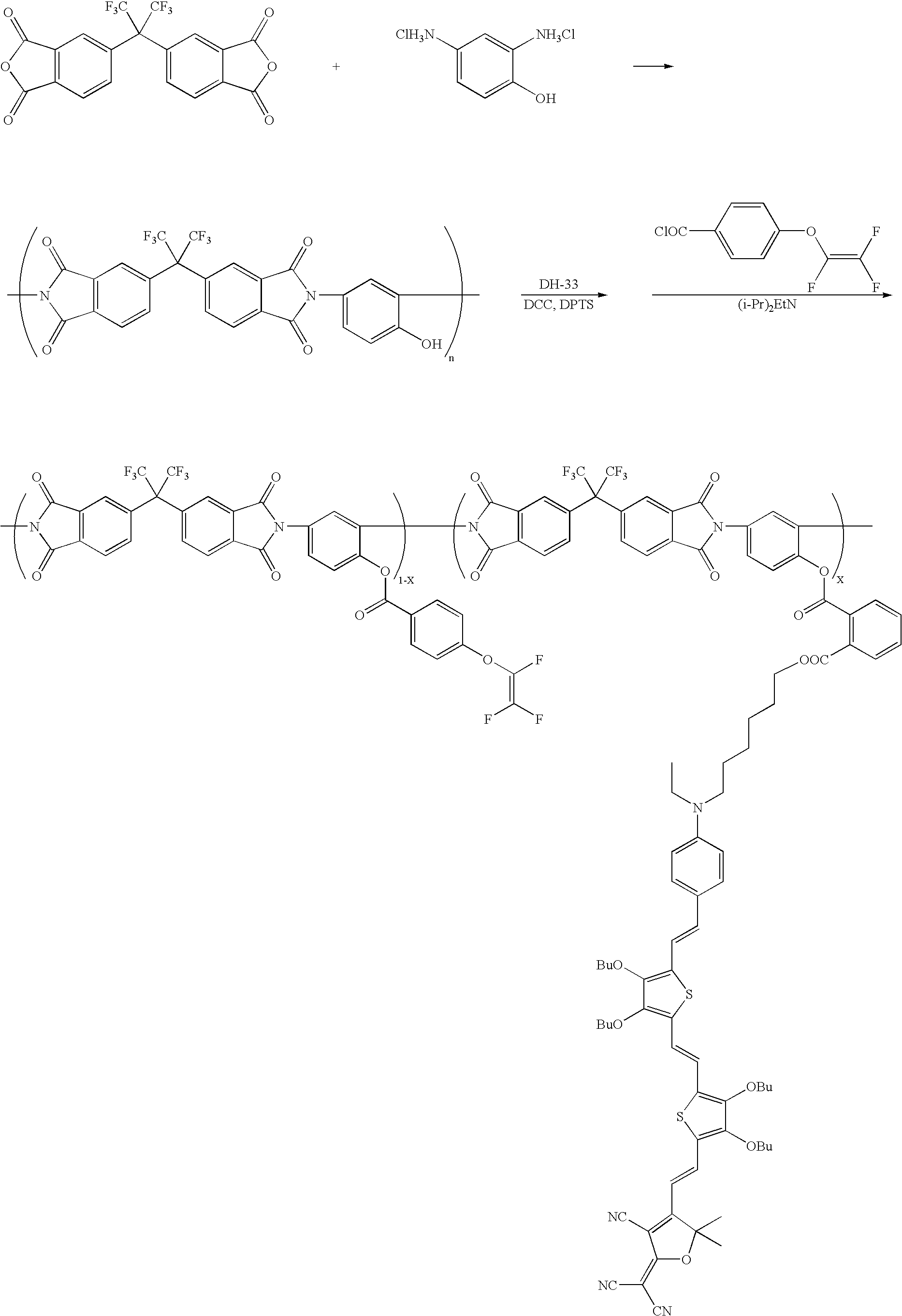

The first step was the synthesis of Polyimide-OH by reacting an aromatic dianhydride with a hydroxy-functional aromatic diamine. Next, the Polyimide-OH (1.75 g, 3.29 mmol), Chromophore DH-33 (0.97 g, 0.894 mmol), and DPTS (0.26 g, 0.894 mmol) were dissolved in a mixture of THF (40 mL) and methylene chloride (13 mL). DCC (0.46 g, 2.235 mmol) was added. The resulting reaction mixture was stirred at rt for 40 h. TFVE-COCL (1.42 g, 5.98 mmol) in 2 mL methylene chloride and (i-Pr)₂EtN (0.87 g, 4.98 mmol) were added stepwise slowly. The resulting reaction mixture was stirred for another 40 h and then poured in MeOH for precipitation. The solid was purified by dissolving in THF and precipitating with MeOH. The product polymer, 2.12 g, was obtained in 67% yield.

### Example B2

A crosslinkable side-chain polyimide was prepared according to the following reaction scheme:

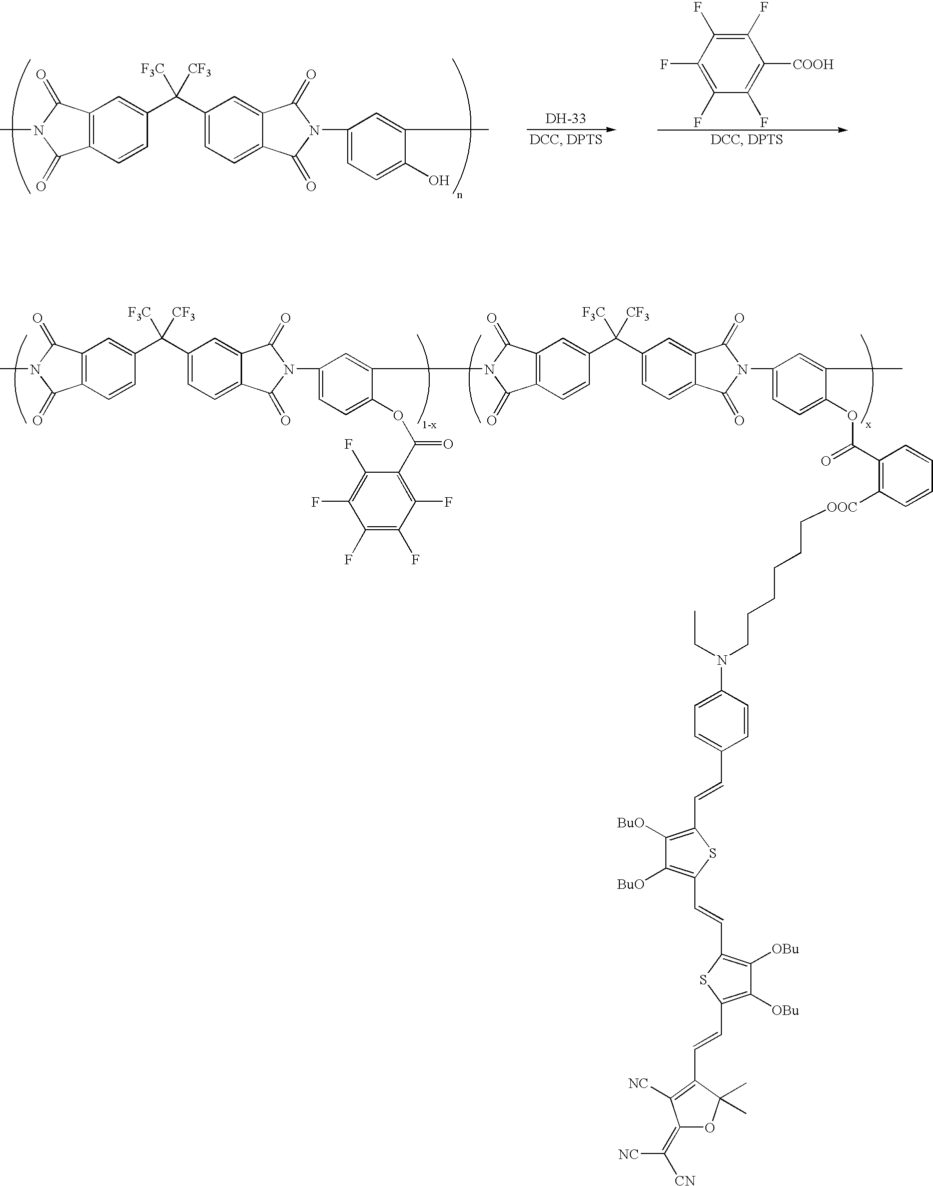

The first step was the synthesis of Polyimide-OH by reacting an aromatic dianhydride with a hydroxy-functional aromatic diamine. Next, the Polyimide-OH (2 g, 3.76 mmol), Chromophore DH-33 (1.38 g, 1.27 mmol), and DPTS (0.37 g, 1.27 mmol) were dissolved in a mixture of THF (45 mL) and methylene chloride (15 mL). DCC (0.66 g, 3.18 mmol) was added. The resulting reaction mixture was stirred at rt for 40 h. Pentafluorobenzoic acid (1.32 g, 6.2 mmol), DPTS (1.83 g, 6.2 mmol), and DCC (2.05 g, 9.9 mmol) were added stepwise slowly. The resulting reaction mixture was stirred for another 40 h and then poured in MeOH for precipitation. The solid was purified by dissolving in THF and precipitating with MeOH. The product polymer, 2 g, was obtained in 52% yield.

### Example B3

A crosslinkable side-chain polyimide was prepared according to the following reaction scheme:

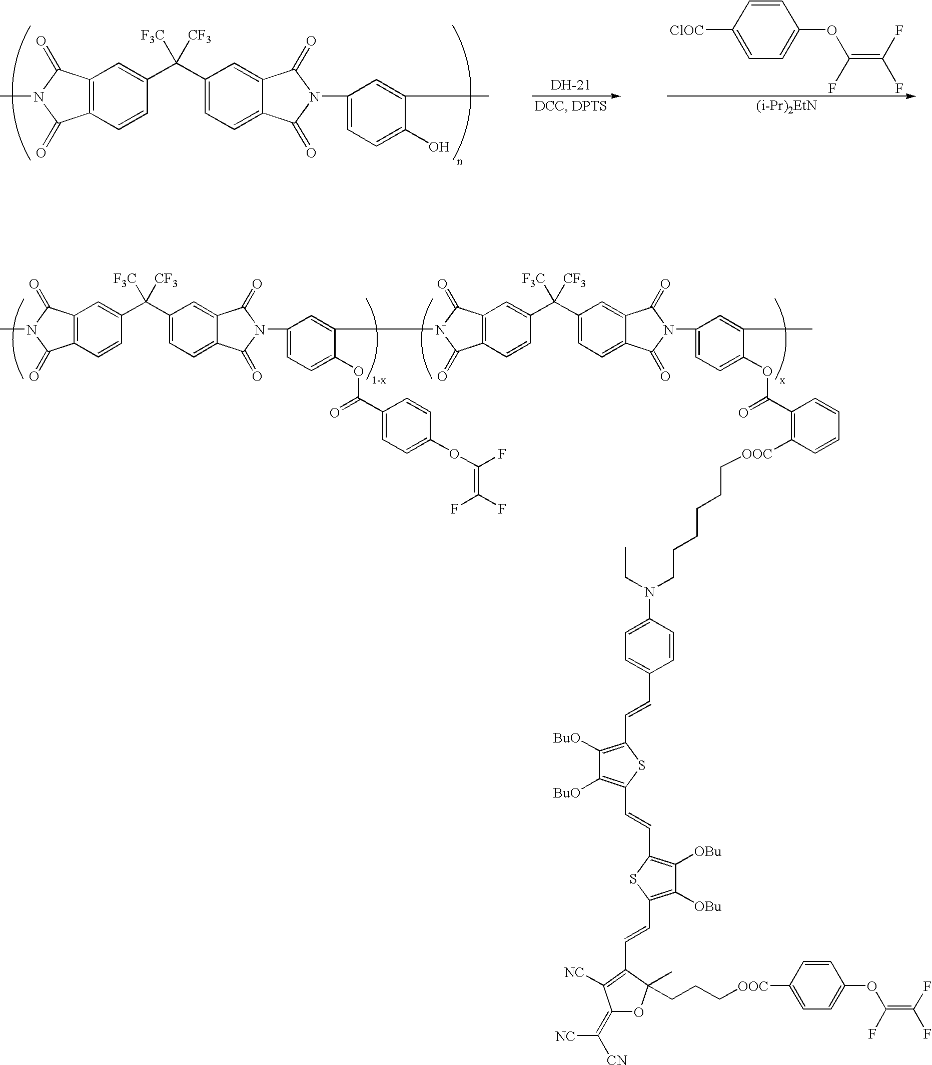

The first step was the synthesis of Polyimide-OH by reacting an aromatic dianhydride with a hydroxy-functional aromatic diamine. Next, the Polyimide-OH (2 g, 3.76 mmol), Chromophore DH-21 (1.69 g, 1.27 mmol), and DPTS (0.37 g, 1.27 mmol) were dissolved in a mixture of THF (45 mL) and methylene chloride (15 mL). DCC (0.66 g, 3.18 mmol) was added. The resulting reaction mixture was stirred at rt for 40 h. TFVE-COCl (1.47 g, 6.2 mmol) in 2 mL methylene chloride and (i-Pr)₂EtN (0.9 mL, 5.2 mmol) were added stepwise slowly. The resulting reaction mixture was stirred for another 40 h and then poured in MeOH for precipitation. The solid was purified by dissolving in THF and precipitating with MeOH. The product polymer, 2.9 g, was obtained in 70% yield.

Crosslinked electro-optic polymer films having thicknesses of 3-5 μm were formed from the polymer by spin coating the polymer as a solution of about 20% by wt. in cyclopentanone onto an ITO-covered glass slide. The residual solvent was then baked out at 80-100° C. under vacuum for several hours. All samples were contact poled at three different temperatures under an applied electric field, after which their r33 values were measured immediately after poling and then 500 hours after poling. The results are set forth in Table 1. They demonstrate that the crosslinked films exhibited good initial r33 values, and substantially retained those values even after 500 hours.

TABLE 1

| | Poling Temperature | | |
|---|---|---|---|
| | 170-180° C. | 190° C. | 200° C. |
| r33/0 hrs | 78.67 | 60.28 | 44.39 |
| r33/500 hrs | 66.51 | 57.46 | 43.57 |
| % retention | 85% | 95% | 98% |

### Example B4

A crosslinkable side-chain polyimide was prepared according to the following reaction scheme:

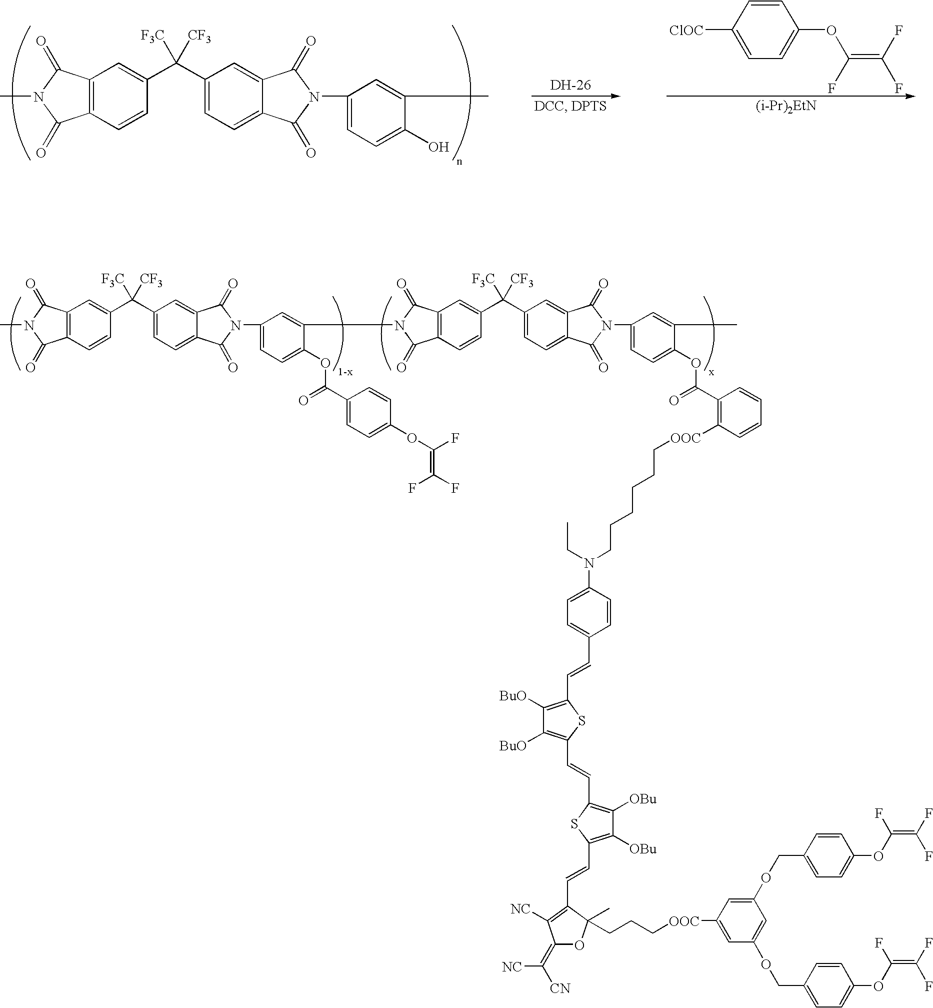

The first step was the synthesis of Polyimide-OH by reacting an aromatic dianhydride with a hydroxy-functional aromatic diamine. Next, the Polyimide-OH (2 g, 3.76 mmol), Chromophore DH-26 (2.08 g, 1.27 mmol), and DPTS (0.37 g, 1.27 mmol) were dissolved in a mixture of THF (45 mL) and methylene chloride (15 mL). DCC (0.66 g, 3.18 mmol) was added. The resulting reaction mixture was stirred at rt for 40 h. TFVE-COCl (1.47 g, 6.2 mmol) in 2 mL methylene chloride and (i-Pr)₂EtN (0.9 mL, 5.2 mmol) were added stepwise slowly. The resulting reaction mixture was stirred for another 40 h and then poured in MeOH for precipitation. The solid was purified by dissolving in THF and precipitating with MeOH. The product polymer, 3.2 g, was obtained in 70% yield.

### Example B5

A crosslinkable side-chain polyimide was prepared according to the following reaction scheme:

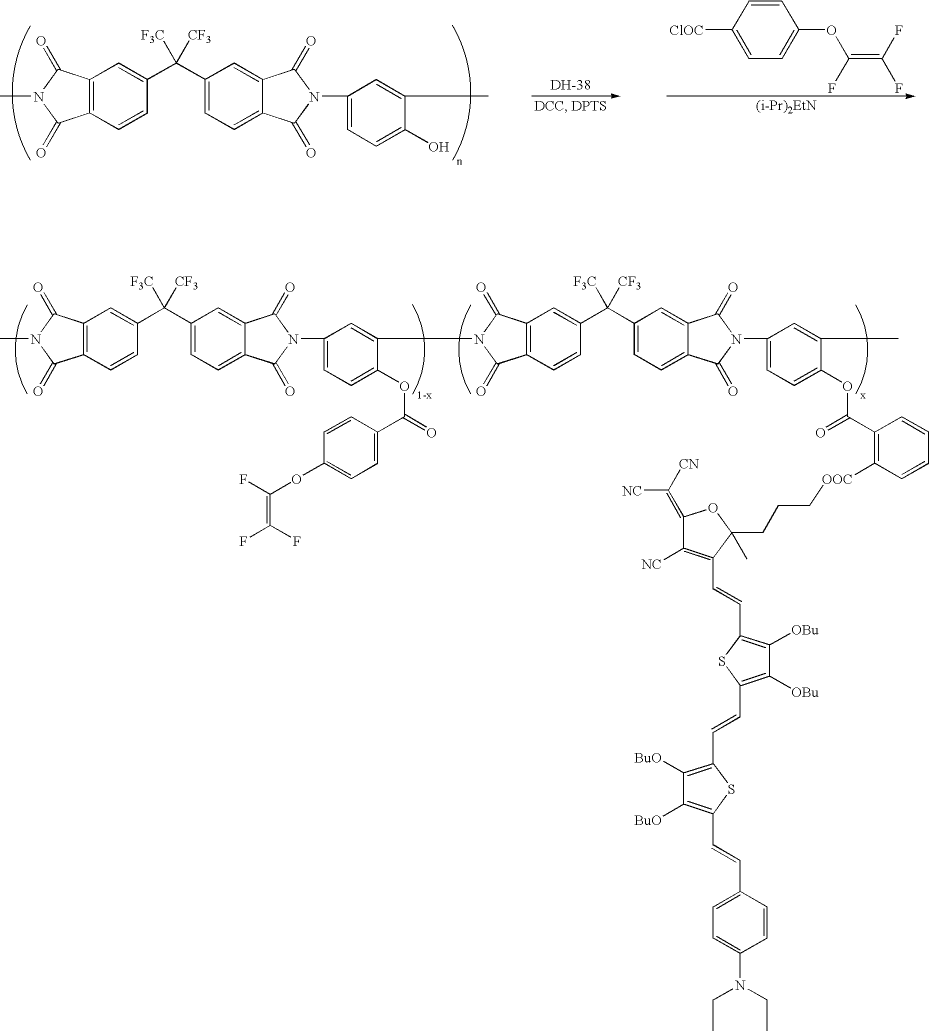

The first step was the synthesis of Polyimide-OH by reacting an aromatic dianhydride with a hydroxy-functional aromatic diamine. Next, the Polyimide-OH (2 g, 3.76 mmol), Chromophore DH-38 (1.34 g, 1.27 mmol), and DPTS (0.37 g, 1.27 mmol) were dissolved in a mixture of THF (45 mL) and methylene chloride (15 mL). DCC (0.66 g, 3.18 mmol) was added. The resulting reaction mixture was stirred at rt for 40 h. TFVE-COCl (1.47 g, 6.2 mmol) in 2 mL methylene chloride and (i-Pr)₂EtN (0.9 mL, 5.2 mmol) were added stepwise slowly. The resulting reaction mixture was stirred for another 40 h and then poured in MeOH for precipitation. The solid was purified by dissolving in THF and precipitating with MeOH. The product polymer, 2.8 g, was obtained in 73% yield.

### Example B6

A crosslinkable side-chain polyimide was prepared according to the following reaction scheme:

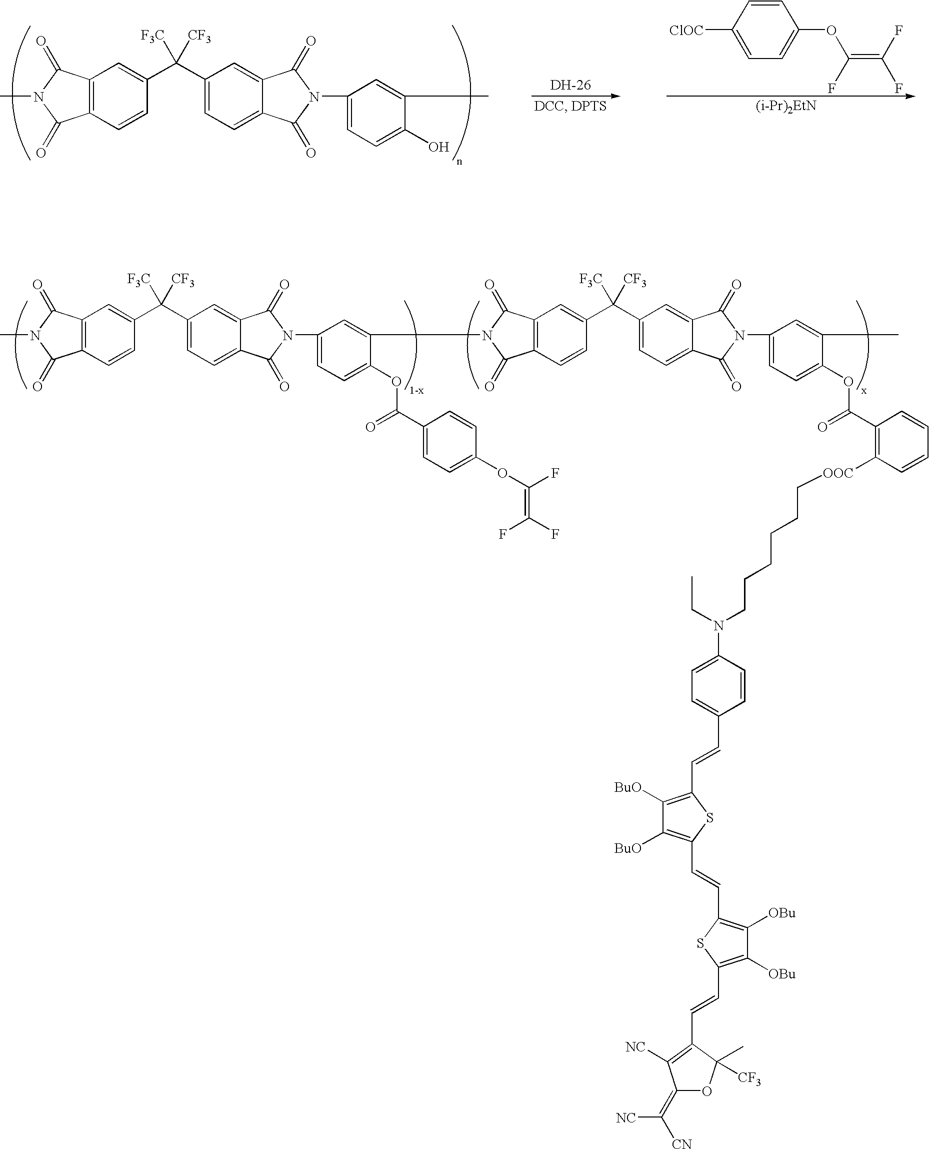

The first step was the synthesis of Polyimide-OH by reacting an aromatic dianhydride with a hydroxy-functional aromatic diamine. Next, the Polyimide-OH (2 g, 3.76 mmol), Chromophore DH-36 (1.44 g, 1.27 mmol), and DPTS (0.374 g, 1.27 mmol) were dissolved in a mixture of THF (45 mL) and methylene chloride (15 mL). DCC (0.655 g, 3.175 mmol) was added. The resulting reaction mixture was stirred at rt for 40 h. TFVE-COCL (1.47 g, 6.2 mmol) in 2 mL methylene chloride and (i-Pr)₂EtN (0.9 g, 5.18 mmol) were added stepwise slowly. The resulting reaction mixture was stirred for another 40 h and then poured in MeOH for precipitation. The solid was purified by dissolving in THF and precipitating with MeOH. The product polymer, 2.36 g, was obtained in 60% yield.

A number of embodiments of the invention have been described. Nevertheless, it will be understood that various modifications may be made without departing from the spirit and scope of the invention. Accordingly, other embodiments are within the scope of the following claims.

What is claimed is:

1. A composition comprising (a) a linear polyimide polymer or copolymer that includes pendant crosslinkable groups, wherein the polymer or copolymer comprises the reaction product of an aromatic dianhydride and an aromatic diamine, and (b) a chromophore having the formula D-π-A where π is a π bridge including a thiophene ring having oxygen atoms bonded directly to the 3 and 4 positions of the thiophene ring, D is a donor, and A is an acceptor.

2. A composition according to claim 1 wherein the crosslinkable groups comprise fluorinated crosslinkable groups.

3. A composition according to claim 1 wherein the crosslinkable groups are selected from the group consisting of pentafluorobenzene, fluorinated vinyl ethers, and combinations thereof.

4. A composition according to claim 1 wherein the aromatic dianhydride, the aromatic diamine, or both, comprise one or more fluorine atoms.

5. A composition according to claim 1 wherein the chromophore is in the form of a pendant group covalently bonded to the polymer or copolymer.

6. A composition according to claim 1 wherein the chromophore is physically combined with the polymer or copolymer to form a guest-host composition.

7. A composition according to claim 1, 5, or 6 wherein the chromophore has the formula: 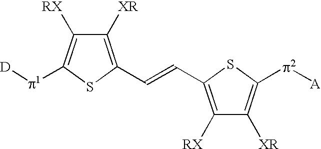
wherein, independently at each occurrence: π¹ is absent or a π-bridge; π² is absent or a π-bridge; D is an donor; A is an acceptor; X is O or S; and R is an alkyl, aryl, heteroalkyl, or heteroaryl group.

8. A composition according to claim 1 wherein the chromophore comprises at least one crosslinkable group.

9. A composition according to claim 1 comprising a copolymer having the formula:

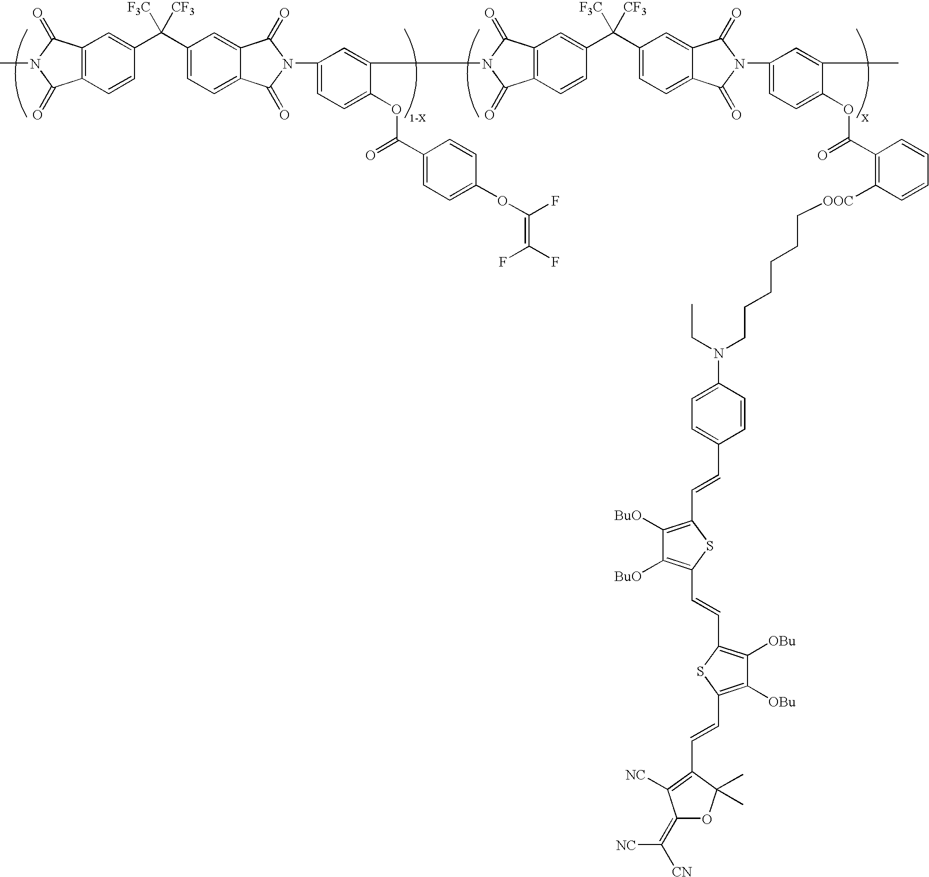

10. A composition according to claim 1 comprising a copolymer having the formula:

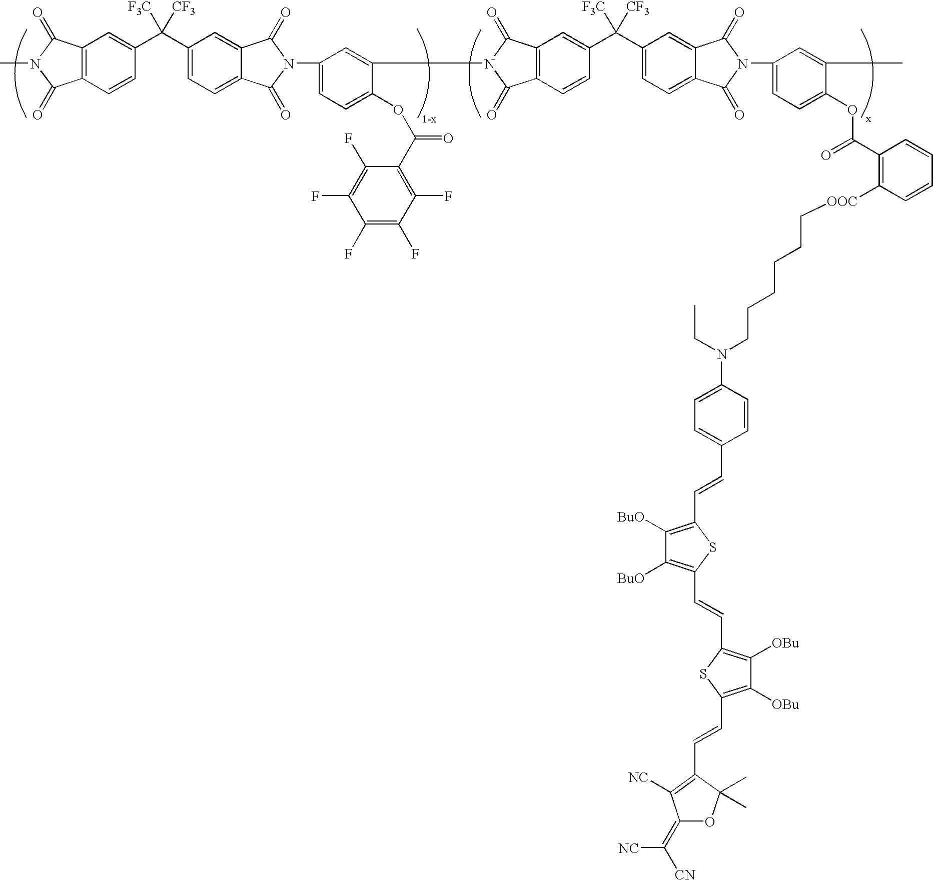

11. A composition according to claim 1 comprising a copolymer having the formula:

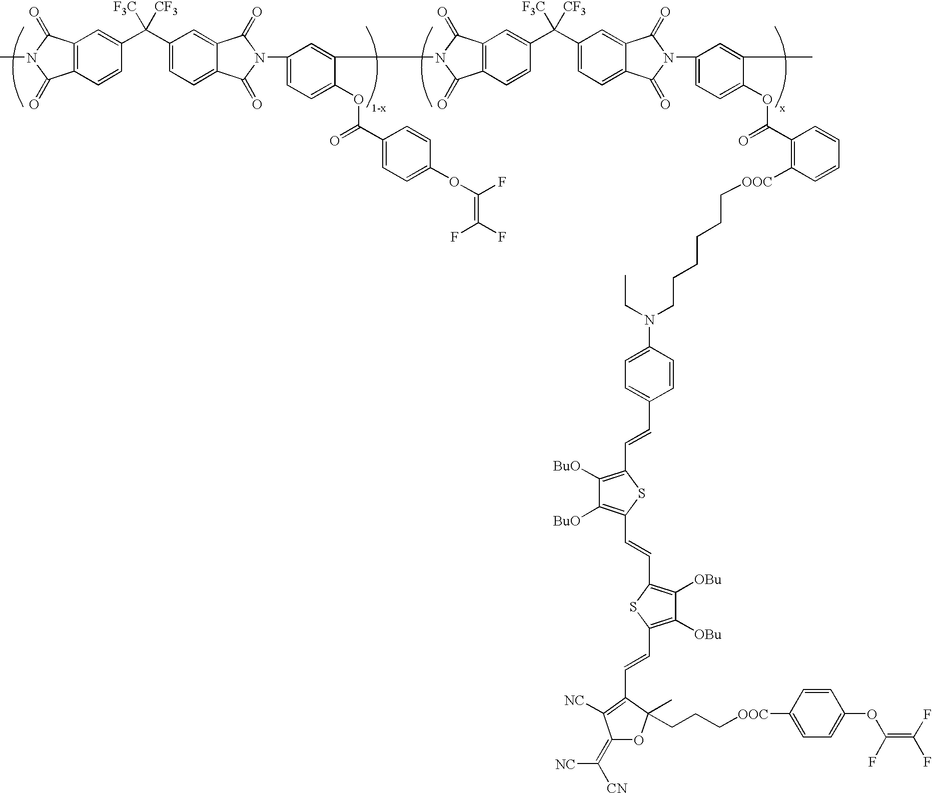

12. A composition according to claim 1 comprising a copolymer having the formula:

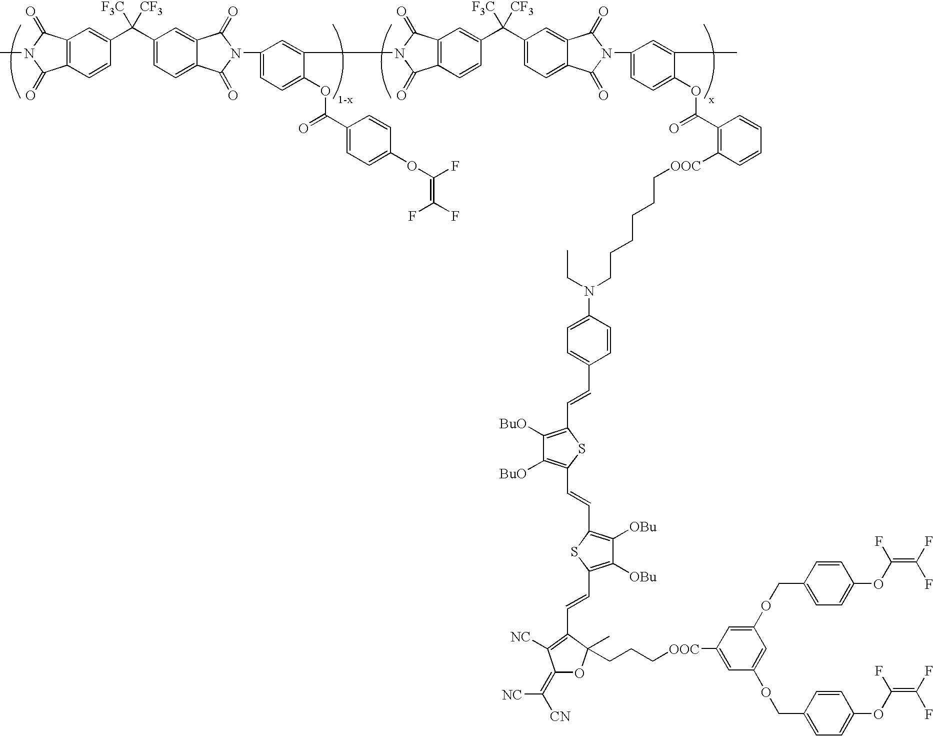

13. A composition according to claim 1 comprising a copolymer having the formula:

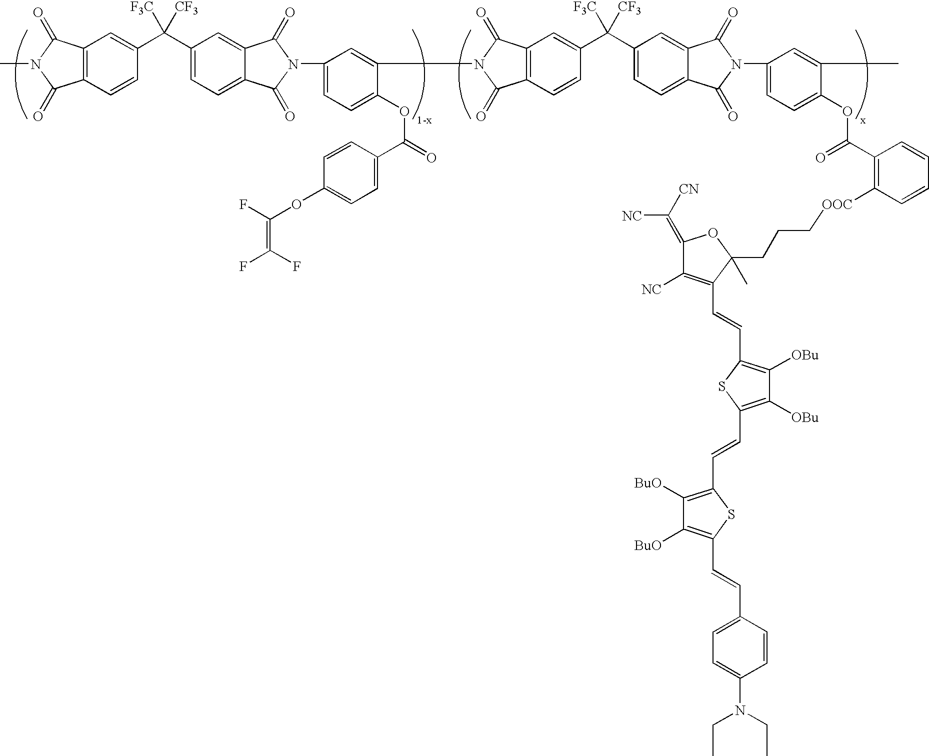

14. A composition according to claim 1 comprising a copolymer having the formula:

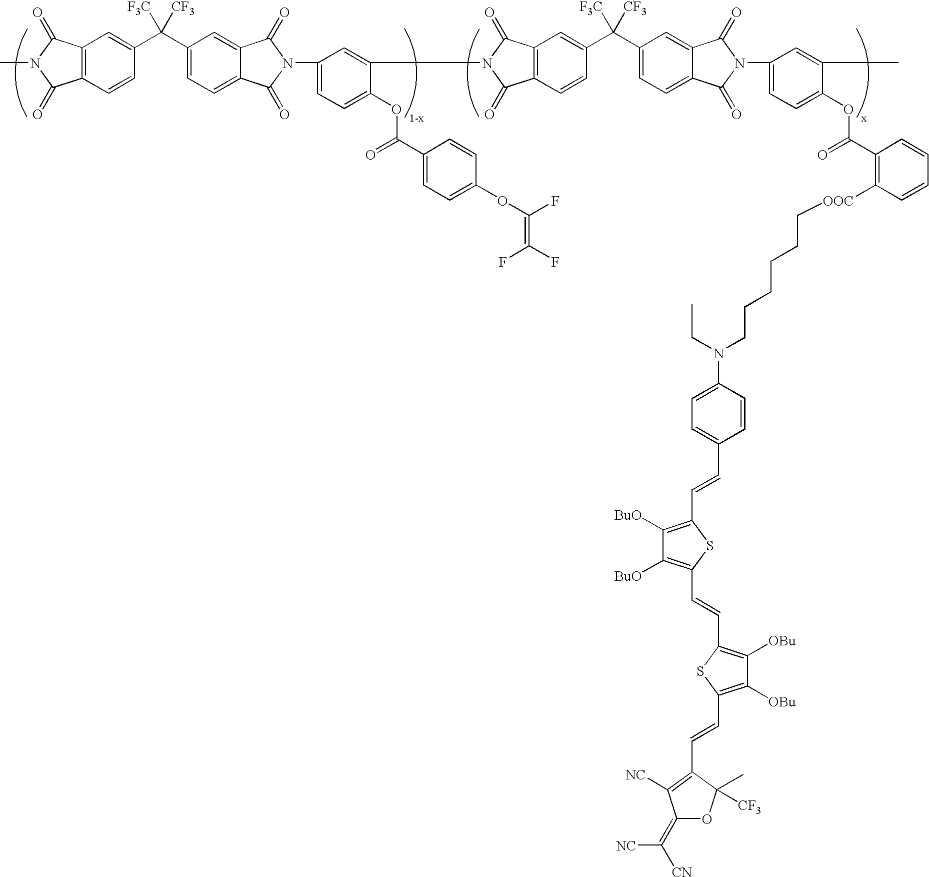

15. An electro-optic device comprising the composition of claim 1.

16. The electro-optic device of claim 15, wherein the electro-optic device is selected from the group consisting of an optical modulator, an optical switch, and an optical directional coupler.

17. The electro-optic device of claim 15, comprising: 1) an input waveguide; 2) an output waveguide; 3) a first leg having a first end and a second end, the first leg being coupled to the input waveguide at the first end and to the output waveguide at the second end; and 4) and a second leg having a first end and a second end, the second leg being coupled to the input waveguide at the first end and to the output waveguide at the second end.

18. The electro-optic device of claim 15, comprising: 1) an input; 2) an output; 3) a first waveguide extending between the input and output; and 4) a second waveguide aligned to the first waveguide and positioned for evanescent coupling to the first waveguide.

19. An optical router including the electro-optic device of claim 15.

20. A communications system including at least one electro-optic device of claim 15.

21. A method of data transmission comprising transmitting light through the composition of claim 1.

22. A method of telecommunication comprising transmitting light through the composition of claim 1.

23. A method of transmitting light comprising directing light through or via the composition of claim 1.

24. A method of routing light through an optical system comprising transmitting light through or via the composition of claim 1.

25. A phased array radar system comprising the composition of claim 1.
